(19) United States
(12) Patent Application Publication
(10) Pub. No.: US 2007/0273163 A1
(43) Pub. Date: Nov. 29, 2007

(54) Door handle system

(76) Inventors: Craig W. Gurtatowski, Crown Point, IN (US); Stephen J. Milchuck, Manhattan, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/707,528

(22) Filed: Feb. 16, 2007

Related U.S. Application Data
(60) Provisional application No. 60/808,079, filed on May 24, 2006.

(51) Int. Cl. E05B 3/00

(52) U.S. Cl. 292/336.3

(57) ABSTRACT

A door handle system may be used in many applications, including the automotive industry and specifically on the inside of an automobile door. Embodiments of the invention include a retainer in the door handle assembly to allow installation in blind areas, where the axle is only visible from the back and the handle only visible from the front. The retainer aligns with a groove in the axle and prevents the axle from backing out of the assembly. Embodiments of the invention ensure a tight fit between the handle and axle preventing the assembly from becoming inoperable if components become loose.

### CROSS REFERENCE TO RELATED APPLICATIONS

This Non-Provisional Application claims benefit to U.S. Provisional Application Ser. No. 60/808,079 filed May 24, 2006.

### FIELD OF THE INVENTION

The present invention relates generally to door handle systems, and more particularly, to automobile inside door handle systems.

### BACKGROUND OF THE INVENTION

It is known that door handles are used in many applications, and are regularly used in the automobile industry. Specifically, door handle systems are used on the inside of automobile doors to facilitate opening of the door by passengers of the vehicle.

Known door handle systems may be assembled in several different ways. Some automotive programs require that a door handle assembly contain a die cast handle and a die cast axle which must attach to each other as well as the handle and a bezel. The die cast parts, which are press fit together, require a secondary attachment to be used for safety. If the press fit were to come loose over time, the assembly could potentially fall apart. If the assembly falls apart, the release handle will no longer function properly.

Other door handle systems use ramps or “C clips” which contact the bezel to prevent the axle from backing out of position and losing contact with the handle. A problem with these systems is that they may not maintain the proper fit between the axle and handle. The assembly will still function if the axle backs out of position, but the handle will feel loose and sloppy, which is undesirable. Also, component parts of these systems may cause interference with the bezel during normal operation, resulting in an undesirable feel of the handle.

Another assembly option for door handle systems is to attach a retaining clip between the axle and handle after assembly. However, with this assembly, access to the area between the axle and handle is not always possible because of the bezel or bracket design. In some instances, only the axle is visible from the back and only the handle is visible from the front.

The present invention is directed at overcoming these and other known drawbacks with existing door handle systems.

### SUMMARY OF THE INVENTION

The present invention is directed to door handle systems that may be used in many applications, including within the automotive industry. The invention provides a door handle system with a retainer attached to an axle that acts as a safety feature to prevent the axle from backing out of the assembly. The invention minimizes interference between assembly parts and with the bezel during operation, and further maintains a firm feel of the handle during operation. The invention may be installed in a blind area, where the axle is visible only from the back of the assembly and the handle is only visible from the front of the assembly. A further feature of the invention is that the retainer may not be removed after the components are assembled. The components of the assembly which are visible remain flush with the handle, providing an aesthetic look and feel for the user.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an isometric view of an assembled embodiment of an exemplary door handle system.

FIG. 2 is an exploded isometric view of parts of an unassembled door handle system.

FIGS. 3a and 3b are isometric views of a handle showing the handle slot and assembly of an exemplary retainer into the handle slot.

FIGS. 4a and 4b are top and bottom views, respectively, of an exemplary retainer.

FIG. 5 is an isometric view of an exemplary axle.

FIG. 6 is a bottom view of a retainer and an isometric view of an axle prior to assembly.

FIG. 7 is an isometric view of an axle engaged with a retainer.

FIG. 8 is an isometric view of an axle, retainer, and handle assembled together.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

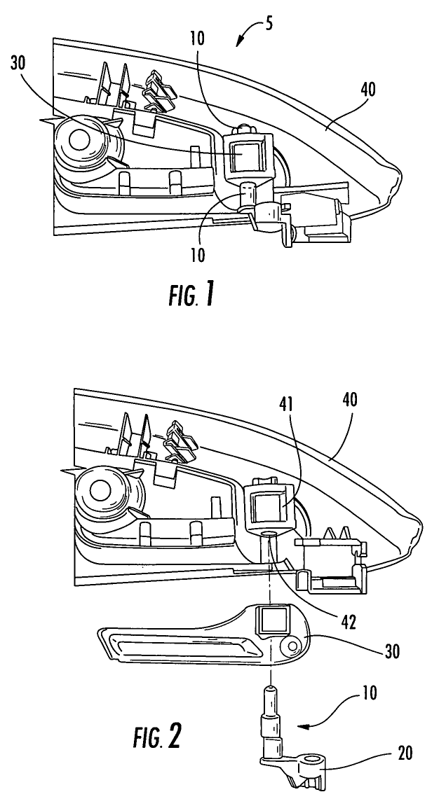

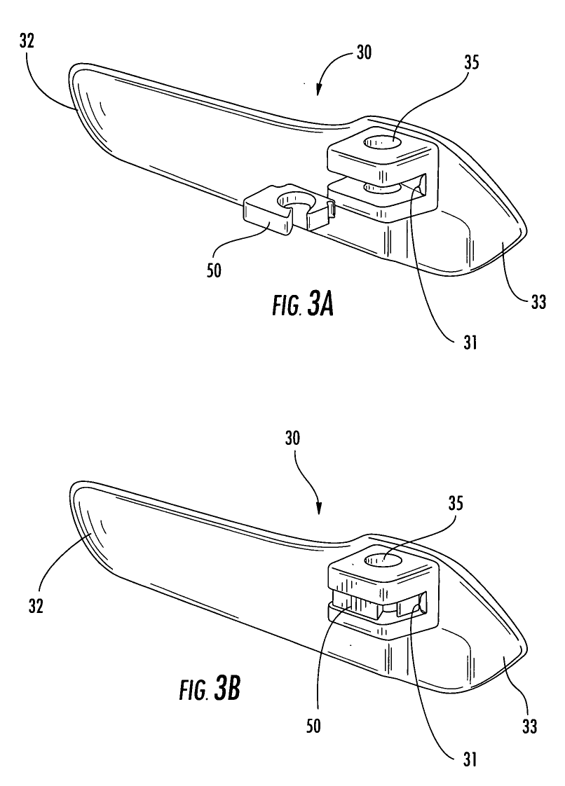

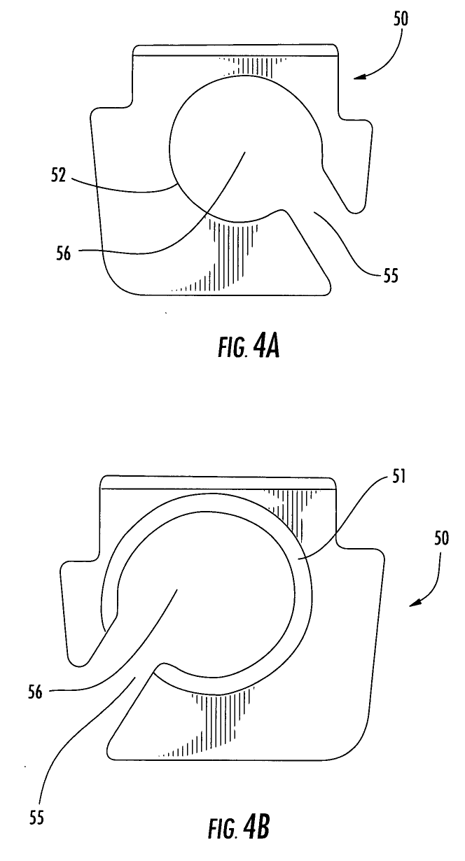

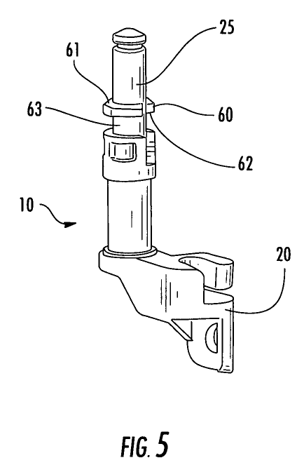

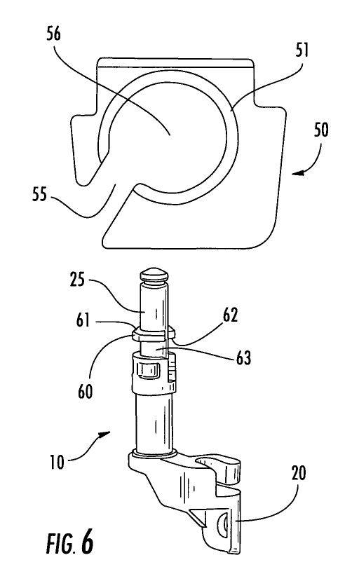

The present invention may be embodied in many forms. One exemplary embodiment, depicted in FIGS. 1 and 2, is a door handle system 5 that may be used on the inside of an automobile door. The door handle system 5 provides a security feature by preventing the door handle 30 from becoming inoperable if press fit components separate. Components of the door handle system 5 include an axle 10, a handle 30, a bezel 40, and a retainer 50, which is shown in FIGS. 3-4. As described in more detail below, with the door handle system 5 of the invention, the axle 10 may be installed through the handle 30, bezel 40 and retainer 50. The retainer 50, which is installed to the handle 30, has an opening that is smaller than the diameter of the axle; however, a slot in the retainer allows the retainer 50 to spread so the axle 10 may pass through the opening. Chamfered surfaces on the installation side of both the axle 10 and retainer 50 allow the axle 10 to pass through the retainer 50, while squared-off surfaces on the opposing sides of the axle and retainer prevent the axle 10 from backing out of the retainer 50 and consequently prevent the axle 10 from backing out of the handle 30. With the embodiments of the invention, the door handle assembly 5 may be prevented from becoming inoperable in the event the press fit between the axle and handle becomes loose.

Referring to FIG. 2, the bezel 40 may be configured to be a fixture to support other components of the door handle system 5. The bezel 40 is also configured to be attached, for example, to the inside of a door frame. The bezel 40 defines an opening 41 configured to engage with the handle 30, and defines an opening 42 to engage with the axle 10. The bezel 40 may be made of any suitable material, such as nylon or acrylonitrile butadiene styrene. Similarly, the retainer 50 may be made of the same material as the bezel 40.

As illustrated in FIGS. 2, 3a, and 3b, the handle 30 comprises a first handle end 32 and a second handle end 33. The first handle end 32 is a free end that provides an area for a user to operate the handle 30. As illustrated in FIGS. 3a and 3b, a surface of the second handle end 33 defines a complimentary shape to that of the bezel 40 so the handle end 33 may engage with the bezel 40. As illustrated in FIG. 3a, a surface of the second handle end 33 defines a slot 31 configured to engage with at least one side of the retainer 50. The second handle end 33 also defines an opening 35 to engage with the axle 10. This engagement is accomplished by the axle end 25 (FIG. 5) being press fit into the opening 35.

FIG. 3b illustrates the retainer 50 engaged with the handle 30 in the handle slot 31. The complementary shapes of the retainer 50 and handle slot 31 permit the retainer 50 to be maintained in position within the handle 30. One of skill in the art will appreciate that the retainer 50 and handle slot 31 may embody many shapes that are complementary and provide the function of maintaining the retainer 50 engaged with the handle 30 in the handle slot 31. Additionally, it is contemplated that the retainer 50 may be formed integral with the handle 30.

FIGS. 4a and 4b depict top and bottom views of the retainer 50. The retainer 50 defines an opening 56 and a slot 55 that extends radially from an edge of the retainer 50 and is in communication with the opening 56. FIG. 4a shows a top view of the retainer 50 and an edge portion 52 of the opening 56, which may be squared-off. In contrast, as shown in FIG. 4b, which is a bottom view of the retainer 50, the edge surface 51 of the opening 56 may be chamfered to facilitate insertion of the axle 10 through the retainer opening 56. The diameter of the opening 56 is configured to be smaller than the diameter of the axle 10. The slot 55 allows the diameter of the opening 56 to expand to permit the axle 10 to be inserted through the opening 56.

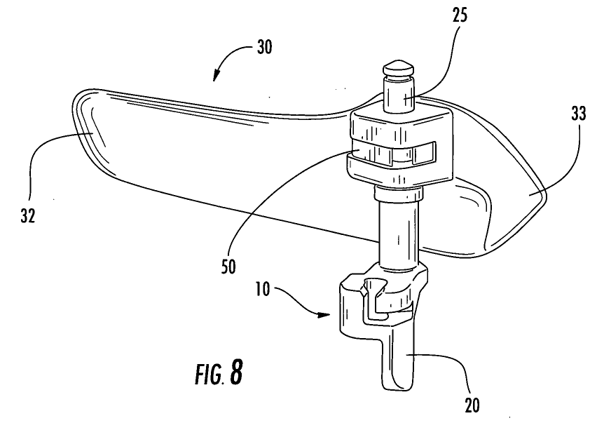

Referring to FIG. 5, axle 10 has a first end 25 and a second end 20. The second end 20 may be configured to engage a cable or a rod that is capable of transferring motion from the handle 30 to a door latch, for example, as known in the art. The first end 25 of the axle 10 includes a groove 63 and a lead-in 60. The lead-in 60 defines a first side 61 and a second side 62. The first side 61 is chamfered to facilitate installation of the axle 10 into the retainer 50 through opening 56, while the second side 62 is squared-off to preclude the axle from being removed from the retainer 50 after assembly. The assembly of the axle 10 to the retainer 50 is further illustrated in FIG. 7. The axle 10 and handle 30 may be made of zinc or any other suitable material.

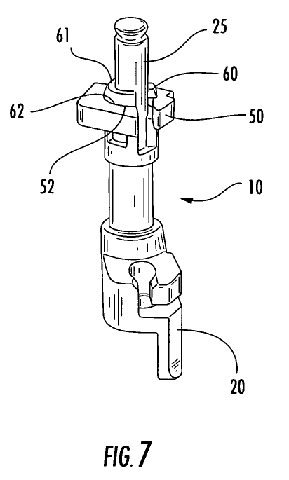

Referring to FIG. 6, the lead-in 60 of the axle 10 may be configured to have a larger diameter than the retainer opening 56. For the axle 10 to be installed into the retainer 50, the retainer slot 55 allows the retainer opening 56 to expand to be larger than the diameter of the lead-in 60. Once the axle 10 is located through the retainer 50, the retainer opening 56 reduces to a diameter smaller than that of the lead-in 60, and the retainer 50 rests in the axle groove 63, as shown in FIG. 7. The lead-in square side 62 and the retainer square side 52 may then be in contact with each other to prevent the axle 10 from being removed from the door handle assembly 5 when fully assembled.

FIG. 8 illustrates the axle 10 assembled to the handle 30 and retainer 50. As illustrated, the end 25 of the axle 10 passes through and engages the retainer 50, as described above (and further shown in FIG. 7), and also engages and is press fit to the handle 30 through the handle opening 35 (FIG. 3b), as described above.

Consequently, with the configuration illustrated in FIGS. 7 and 8, the door handle system 5 which utilizes the retainer 50 may be prevented from becoming inoperable in the event the press fit between the axle and handle becomes loose, thus overcoming the known drawbacks with existing door handle systems.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A door handle system comprising:
a bezel configured to be attached to the inside of a door frame, wherein a surface of the bezel defines a bezel opening,
a handle comprising a first end and a second end, the second end configured to engage the bezel opening, wherein a surface of the second end comprises a handle slot and a handle opening,
a retainer defining a retainer opening and a retainer slot, the retainer opening defining a diameter, the retainer slot extending radially from an edge of the retainer to the retainer opening, the retainer configured to engage the handle slot, and
an axle configured to be installed through the retainer opening, the axle defining a diameter greater than the retainer opening diameter, the axle further defining a first end and a second end, the first end configured to engage the handle opening, the first end defining a groove for receiving the retainer and a lead-in.

2. The door handle system of claim 1 wherein the retainer opening further comprises a first edge portion and a second edge portion, wherein the first edge portion is chamfered and the second edge portion is squared-off.

3. The door handle system of claim 1 wherein the retainer is configured to be aligned in the groove of the axle.

4. The door handle system of claim 1 wherein the retainer slot allows the retainer opening to expand to a diameter larger than the axle diameter.

5. The door handle system of claim 1 wherein the axle lead-in has a first side and a second side, the first side being chamfered and the second side being squared-off.

6. The door handle system of claim 1 wherein the retainer is configured to prevent movement of the retainer in relation to the handle.

7. The door handle system of claim 1 wherein the bezel is made of nylon.

8. A door handle system comprising:
a bezel configured to be attached to the inside of a door frame, wherein a surface of the bezel defines a bezel opening,
a handle comprising a first end and a second end, the second end engaging the bezel opening, and a surface of the second end defining a handle slot and a handle opening,
a retainer configured to engage the handle slot, the retainer defining a retainer opening and a retainer slot, the retainer opening defining a diameter, the slot extending radially from an edge of the retainer to the retainer opening, the retainer opening capable of being expanded, the retainer opening defining a chamfered edge portion and a squared-off edge portion, and
an axle configured to be installed through the retainer opening, the axle having a diameter greater than the retainer opening diameter, the axle comprising a first end and a second end, the first end configured to engage the handle opening and comprising a lead in and a groove configured to engage the retainer, the lead in configured to have a chamfered side and a squared-off side.

9. The door handle system of claim 8 wherein the retainer is configured to be aligned in the groove of the axle.

10. The door handle system of claim 8 wherein removal of the retainer is prevented after assembly of the door handle system.

11. The door handle system of claim 8 wherein the retainer is configured to prevent movement of the retainer in relation to the handle.

12. The door handle system of claim 8 wherein the door handle system is configured to be attached to the inside of an automobile door.

13. A door handle system comprising:
a bezel configured to be attached to the inside of a door frame, wherein a surface of the bezel defines a bezel opening,
a handle comprising a first end and a second end, the second end engaging the bezel opening, and a surface of the second end defining a handle slot and a handle opening,
a retainer configured to engage the handle slot, the retainer defining a retainer opening and a retainer slot, the retainer opening defining a diameter, the retainer slot extending radially from an edge of the retainer to the retainer opening, the retainer opening capable of being expanded and comprising a chamfered edge portion and a squared-off edge portion, and
an axle configured to be installed through the retainer opening, the axle having a diameter greater than the retainer opening diameter, the axle comprising a first end and a second end, the first end configured to engage the handle opening and comprising a lead-in and a groove configured to engage the retainer, the lead-in configured to have a chamfered side and a squared-off side,
wherein the retainer is configured to be aligned in the groove of the axle and wherein removal of the retainer is prevented after assembly of the door handle system.

14. The door handle system of claim 13 wherein the retainer is configured to prevent movement of the retainer in relation to the handle.

15. The door handle system of claim 13 wherein the door handle system is configured to be attached to the inside of an automobile door.

16. The door handle system of claim 13 wherein the bezel is made of nylon.

17. The door handle system of claim 13 wherein the retainer slot allows the retainer opening to expand to a diameter larger than the axle diameter.

18. The door handle system of claim 16 wherein the bezel and retainer are made of the same material.

19. The door handle system of claim 13 wherein the axle is made of zinc.

20. The door handle system of claim 19 wherein the retainer prevents removal of the axle from the handle.
